(19) United States
(12) Patent Application Publication
(10) Pub. No.: US 2001/0002350 A1
(43) Pub. Date: May 31, 2001

(54) Female connection terminal

(76) Inventors: Maki Kashiyama, Shizuoka (JP); Yoshinori Uchida, Shizuoka (JP)

Correspondence Address: SUGHRUE, MION, ZINN, MACPEAK & SEAS, PLLC, 2100 Pennsylvania Avenue, N.W., Washington, DC, 20037, US

(21) Appl. No.: 09/725,857

(22) Filed: Nov. 30, 2000

(30) Foreign Application Priority Data
Nov. 30, 1999 (JP) P.HEI.11-340377

(51) Int. Cl. H01R 11/22; H01R 13/11

(52) U.S. Cl. 439/848; 439/852; 439/851; 439/853; 439/854

(57) ABSTRACT

A female connection terminal (1) includes a box-shaped connection portion (4), and a resilient contact piece portion (5) which is folded back from a front end of the connection portion (4) toward a rear end of an internal space of the connection portion (4). An insertion space (7) is formed between an upper surface of the resilient contact piece portion (5) and an inner surface of the connection portion (4), and a male connection terminal (45) can be inserted into this insertion space to be held in resilient contact with the resilient contact piece portion (5). A projection (8) is formed on the upper surface of the resilient contact piece portion (5), and this projection has a slanting surface substantially conforming to a slanting surface (46) formed at a distal end portion of the male connection terminal (45) which can be inserted into the insertion space (7) at a predetermined insertion angle. Therefore, the female connection terminal (1) suppresses an abrupt increase of an insertion resistance of the male connection terminal (45) relative to the projection (8), and its maximum insertion resistance value can be kept to a low level.

### BACKGROUND OF THE INVENTION

1. Field of the Invention

The present invention relates to a female connection terminal in which a resilient contact piece portion for resilient contact with a male connection terminal is provided within an internal space of a box-shaped connection portion. More particularly, the present invention relates to such a female connection terminal in which the resistance to the insertion of the male connection terminal is reduced.

The present application is based on Japanese Patent Application No. Hei. 11-340377, which is incorporated herein by reference.

2. Description of the Related Art

Female connection terminals of various constructions are already known. An example of a related female connection terminal has been disclosed in Unexamined Japanese Patent Publication No. Hei. 8-45593. As shown in FIGS. 5 to 7, the related female connection terminal 51 is formed by bending a metal sheet into a predetermined shape, and this terminal 51 includes a sheath clamping portion 52 for press-holding a sheath 42 of a wire 41, a conductor clamping portion 53 for press-holding a front end portion of a conductor 43, from which the sheath 42 is removed, and a box-shaped connection portion 54 formed at a front end portion thereof to be opposed to a male connection terminal 45.

As shown in FIGS. 6 and 7, the box-shaped connection portion 54 has a resilient contact piece portion 55 which is folded back from the front end of the connection portion 54 toward a rear end of an internal space of this connection portion 54. An insertion space 57 is formed between an upper surface of the resilient contact piece portion 55 and an inner surface of a top plate 56 of the connection portion 54, and the male connection terminal 45 can be inserted into this insertion space 57 through an opening 57a at the front end of the connection portion 54, and the male connection terminal 45, inserted into the insertion space 57, is held in resilient contact with the upper surface of the resilient contact piece portion 55. In order to ensure the electrical contact, an upwardly-bulging contact 58 is formed on the upper surface of the resilient contact piece portion 55 while two elongate projections 59 are formed on the inner surface of the top plate 56, and extend in a direction of the length thereof.

Particularly, the resilient contact piece portion 55 is folded back into a U-shape from a folded-back portion 61 at a front end of a bottom plate 60 (forming part of the connection portion 54) to be disposed inwardly of the insertion space 57, and this resilient contact piece portion 55 further extends rearwardly in an upwardly-slanting manner, and then is folded back into a hair pin-shape toward the bottom plate 60 to provide a folded portion 62.

When the resilient contact piece portion 55 is disposed in its natural condition, the folded portion 62 floats off the bottom plate 60. When the male connection terminal 45 with a predetermined thickness is inserted, the folded portion 62 is brought into resilient contact with the bottom plate 60.

When the male connection terminal 45 is inserted into the insertion space 57 through the opening 57a in parallel relation to the top plate 56, this male connection terminal 45 abuts against the contact 58, and gradually presses the resilient contact piece portion 55 downwardly in accordance with this inserting operation. As a result, as shown in FIG. 6, the resilient contact piece portion 55 is gradually bent or elastically deformed about the folded-back portion 61 downwardly toward the bottom plate 60, so that the male connection terminal 45 is resiliently held between the contact 58 and the elongate projections 59, thereby maintaining the electrically-connected condition relative to the male connection terminal 45.

In the above related female connection terminal 51, the male connection terminal 45 is resiliently held between the contact 58, having a semi-circular cross-sectional shape in the axial direction, and the elongate projections 59, thereby maintaining the electrically-connected condition. Therefore, when the male connection terminal 45 is inserted in a horizontally-disposed posture into the insertion space 57 through the opening 57a, the distal end of the male connection terminal 45 first abuts against the contact 58 at an abutment point Q as shown in FIG. 6. Then, the male connection terminal is further inserted a predetermined distance to move in sliding contact with the surface of the contact 58 of a semi-circular cross-section, and the insertion resistance of the connection terminal 45 abruptly increases to a maximum value (high level) as indicated in a broken line in FIG. 4. And besides, there has been encountered another problem that the distal end of the male connection terminal 45 and the slanting surface at the distal end portion thereof are damaged, so that the reliability of the connection and the electrical contact are lowered.

### SUMMARY OF THE INVENTION

The present invention seeks to solve the above problems of the related art, and an object of the present invention is to provide a female connection terminal which enables a male connection terminal to be smoothly inserted thereinto without damaging this male connection terminal, thereby maintaining a good electrical connection between the two terminals.

To achieve the above object, according to the first aspect of the present invention, there is provided a female connection terminal which comprises a connection portion having a hollow internal space therein, a resilient contact piece portion, which is folded back from a front end of the connection portion, and is extended in the internal space of the connection portion toward a rear end of the connection portion, so that an insertion space, in which a male connection terminal is insertable, is formed between an upper surface of the resilient contact piece portion and an inner surface of the connection portion, and a projection formed on the upper surface of the resilient contact piece portion, the projection having a slanting surface substantially conforming to a slanting surface formed on a distal end portion of the male connection terminal when the male connection terminal is inserted in the insertion space.

Accordingly, the female connection terminal suppresses an abrupt increase of an insertion resistance of the male connection terminal relative to the projection, and its maximum insertion resistance value can be kept to a low level.

According to the second aspect of the present invention, it is further preferable that the slanting surface of the male connection terminal is substantially parallel to the slanting surface of the projection when the male connection terminal is inserted in the insertion space substantially in parallel with a bottom plate of the connection portion.

According to the third aspect of the present invention, it is further preferable that the slanting surface of the male connection terminal and the slanting surface of the projection are smoothly and uniformly formed.

According to the fourth aspect of the present invention, it is further preferable that the female connection terminal further comprises a pair of stoppers respectively formed on opposite side edge of the resilient contact piece portion, and windows, in which stoppers are received, respectively formed through side plates of the connection portion.

### BRIEF DESCRIPTION OF THE DRAWINGS

FIG. 1 is a partly-broken, perspective view of a female connection terminal of the present invention;

FIG. 2 is an enlarged, perspective view of a resilient contact piece portion in FIG. 1;

FIG. 3 is a vertical cross-sectional view of a connection portion in FIG. 1;

FIG. 4 is a graph showing the relation between an insertion resistance of a male connection terminal and an insertion distance with respect to the female connection terminal of the present invention and a related female connection terminal;

FIG. 5 is a perspective view showing a related female connection terminal;

FIG. 6 is a vertical cross-sectional view of a portion of the related female connection terminal of FIG. 5 in its connected condition; and

FIG. 7 is a front-elevational view of the related female connection terminal of FIG. 5.

### DETAILED DESCRIPTION OF THE PREFERRED EMBODIMENT

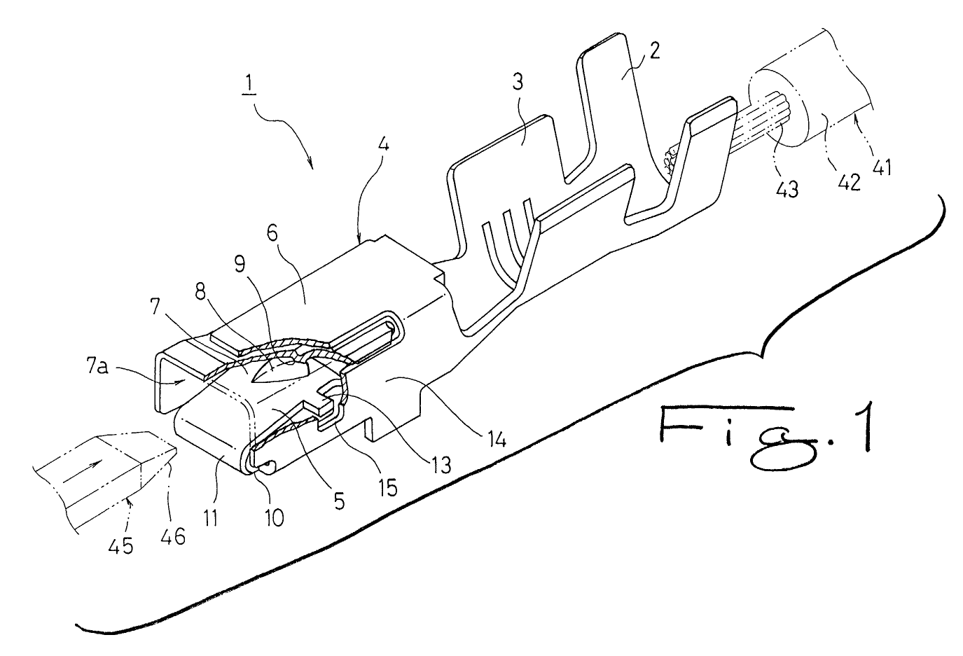

One preferred embodiment of a female connection terminal of the present invention will now be described in detail with reference to FIGS. 1 to 4.

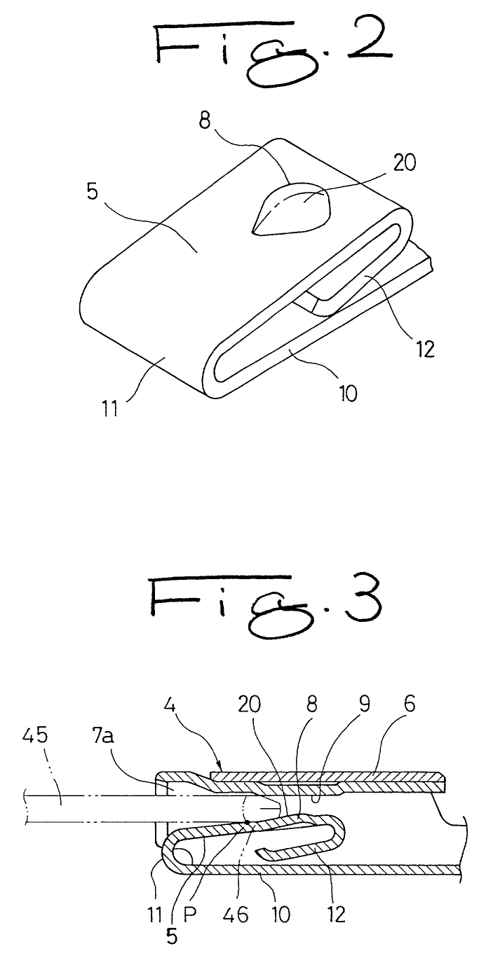

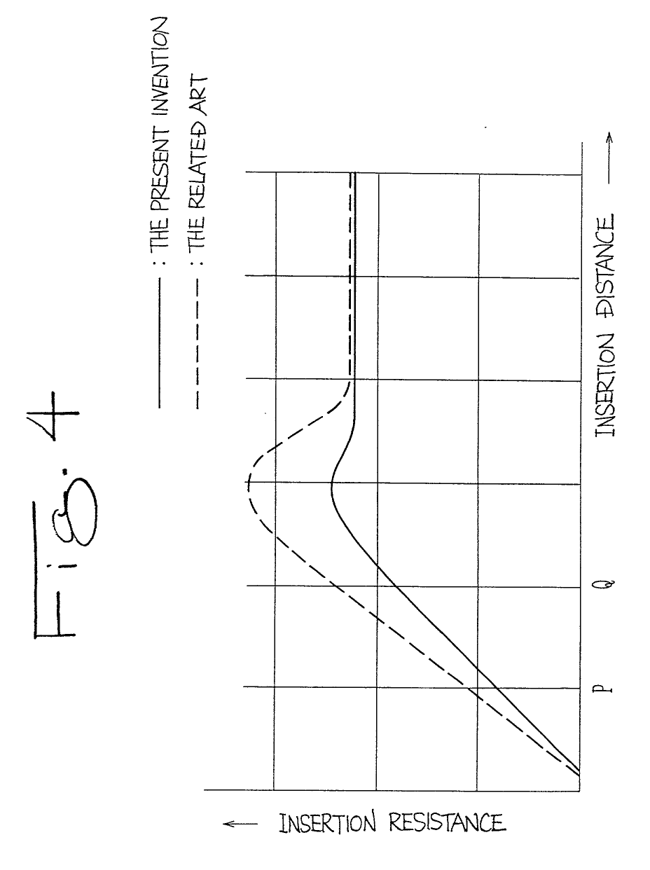

FIG. 1 is a partly-broken, perspective view of the female connection terminal of the present invention, FIG. 2 is an enlarged, perspective view of a resilient contact piece portion in FIG. 1, FIG. 3 is a vertical cross-sectional view of a connection portion in FIG. 1, and FIG. 4 is a graph showing the relation between an insertion resistance of a male connection terminal and an insertion distance with respect to the female connection terminal of the present invention and the related female connection terminal.

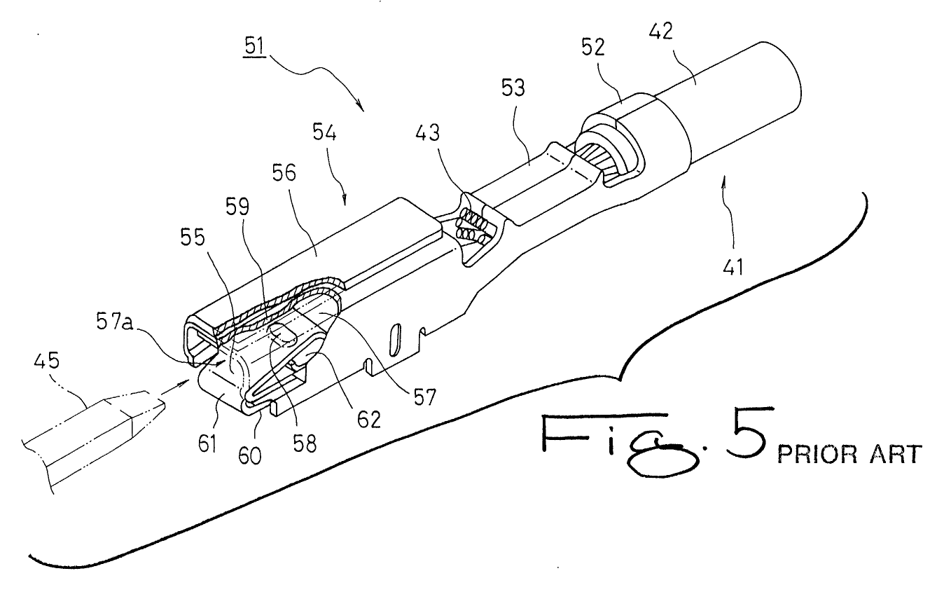

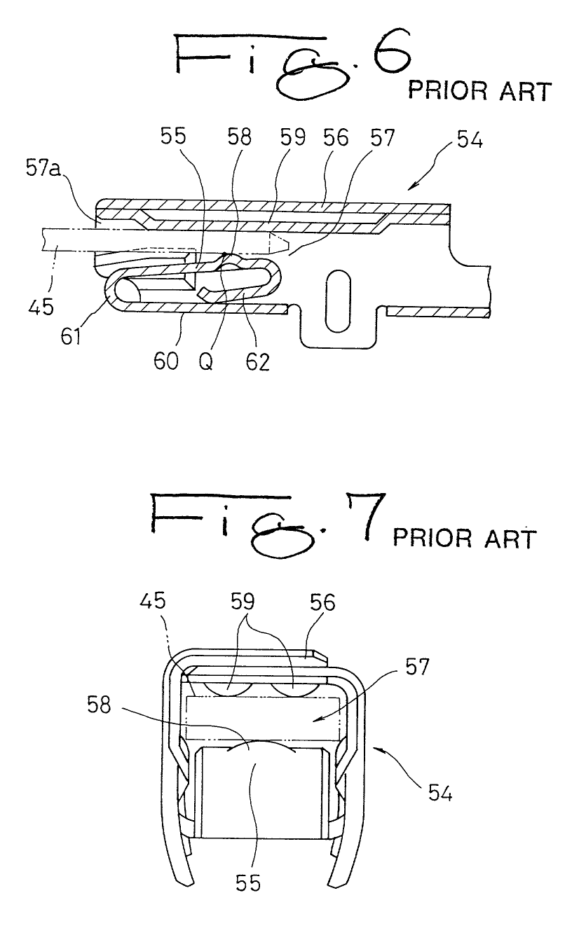

As shown in FIG. 1, most of the construction of the female connection terminal 1 of this embodiment is substantially similar to that of the related female connection terminal 51 (see FIG. 5). Namely, this female terminal is formed by bending a metal sheet into a predetermined shape, and includes a sheath clamping portion 2 for press-holding a sheath 42 of a wire 41, a conductor clamping portion 3 for press-holding a front end portion of a conductor 43, from which the sheath 42 is removed, and the box-shaped connection portion 4 formed at a front end portion thereof to be opposed to the male connection terminal 45.

As shown in FIGS. 1 and 2, the connection portion 4 has the resilient contact piece portion 5 which is folded back from the front end of the connection portion 4 toward a rear end of an internal space of this connection portion 4. An insertion space 7 is formed between an upper surface of the resilient contact piece portion 5 and an inner surface of the connection portion 4, and the male connection terminal 45 can be inserted into this insertion space 7 through an opening 7a at the front end of the connection portion 4, and the male connection terminal 45, inserted into the insertion space 7, is held in resilient contact with the upper surface of the resilient contact piece portion 5.

A feature of the female connection terminal 1 of this embodiment resides in the fact that in order to ensure the electrical contact, a slightly upwardly-bulging projection 8 of a water drop-like shape is formed on a generally intermediate portion of the slanting upper surface of the resilient contact piece portion 5. This projection 8, projecting from the slanting upper surface of the resilient contact piece portion 5, substantially conforms to a slanting surface 46 formed at a distal end portion of the male connection terminal 45. In other words, the projection 8 has a streamline-shaped slanting surface 20 generally parallel to the slanting surface 46 at the distal end portion of the male connection terminal 45.

As shown in FIG. 2, the resilient contact piece portion 5 is folded back into a U-shape from a folded-back portion 11 at a front end of a bottom plate 10 (forming part of the connection portion 4) to be disposed inwardly of the insertion space 7, and this resilient contact piece portion 5 further extends rearwardly in an upwardly-slanting manner, and then is folded back into a hair pin-shape toward the bottom plate 10 to provide a folded portion 12.

As shown in FIG. 3, the folded portion 12 floats off the bottom plate 10, and when the male connection terminal 45 with a predetermined thickness is inserted, the resilient contact piece portion 5 is gradually pressed down, so that the folded portion 12 is brought into resilient contact with the bottom plate 10.

As a result, the resilient contact piece portion 5 is gradually bent or elastically deformed about the folded-back portion 11 downwardly toward the bottom plate 10, so that the male connection terminal 45 is resiliently held between the projection 8 and an inner surface of a top plate 6, thereby maintaining the electrically-connected condition relative to the male connection terminal 45.

Namely, when the male connection terminal 45 is inserted into the insertion space 7 through the opening 7a at such an insertion angle that the axis of the male connection terminal 45 is parallel to the bottom plate 10, the slanting surface 46 at the distal end portion of the male connection terminal 45 approaches the slanting upper surface of the resilient contact piece portion 5, and is brought into contact with the resilient contact piece portion 5 at a first contact point P, disposed immediately before the projection 8, and is further inserted a predetermined distance in slight sliding contact with the slanting surface 20 of the projection 8 projecting upwardly in substantially-conforming relation to the slanting surface 46 of the distal end portion of the male connection terminal 45.

More particularly, it is preferable that the slanting surface 46 of the male connection terminal 46 is substantially parallel to the slanting surface 20 of the projection 8 when the male connection terminal 46 is inserted substantially in parallel with the bottom plate 10 of the connection portion 4.

Therefore, as indicated by a solid line in FIG. 4, the female connection terminal 1 suppresses an abrupt increase of the insertion resistance of the male connection terminal 45 relative to the projection 8, and therefore the maximum insertion resistance value of the male connection terminal 45 can be kept to a low level.

Preferably, the slanting surface 20 of the projection 8 should be formed as smoothly and uniformly as possible in order to suppress an abrupt increase of the insertion resistance of the male connection terminal 45 relative to the projection 8. Similarly, the slanting surface 46 of the male connection terminal 45 should also be formed as smoothly and uniformly as possible.

However, the angle of insertion of the connection terminal 45 should not be limited to such an angle that the axis of the connection terminal 45 is parallel to the bottom plate 10. Even when the connection terminal 45 is inserted at such an insertion angle that this terminal slidingly contacts the slanting surface 20 of the projection 8 relatively strongly, the abrupt increase of the insertion resistance is suppressed by the slanting surface 20, and its maximum insertion resistance value is kept to a relatively low level.

As shown in FIG. 1, a pair of projection-like stoppers 13 are formed on opposite side edges of a generally intermediate portion of the resilient contact piece portion 5, and windows 15, receiving the stoppers 13, are respectively formed through side plates 14 of the connection portion 4. When the male connection terminal 45 is inserted from a position disposed obliquely upwardly of the connection portion 4, the stoppers 13 and the windows 15 cooperate with each other to prevent the resilient contact piece portion 5 from being excessively elastically deformed.

As described above, in the female connection terminal of the present invention, the projection is formed on the upper surface of the resilient contact piece portion, and the projection has the slanting surface substantially conforming to the slanting surface formed at the distal end portion of the male connection terminal which can be inserted into the insertion space at the predetermined insertion angle.

Therefore, the female connection terminal suppresses an abrupt increase of the insertion resistance of the male connection terminal relative to the projection, and its maximum insertion resistance value can be kept to a low level. Therefore, the male connection terminal can be inserted smoothly and easily, and the good electrically-connected condition is maintained, and besides damage of the male connection terminal is prevented. Therefore, there can be obtained the female connection terminal of high reliability.

What is claimed is:

1. A female connection terminal, comprising:
a connection portion having a hollow internal space therein;
a resilient contact piece portion, which is folded back from a front end of the connection portion, and is extended in the internal space of the connection portion toward a rear end of the connection portion, so that an insertion space, in which a male connection terminal is insertable, is formed between an upper surface of the resilient contact piece portion and an inner surface of the connection portion; and
a projection formed on the upper surface of the resilient contact piece portion, the projection having a slanting surface substantially conforming to a slanting surface formed on a distal end portion of the male connection terminal.

2. The female connection terminal of claim 1, wherein the slanting surface of the male connection terminal is substantially parallel to the slanting surface of the projection when the male connection terminal is inserted in the insertion space.

3. The female connection terminal of claim 1, wherein the slanting surface of the male connection terminal is substantially parallel to the slanting surface of the projection when the male connection terminal is inserted in the insertion space substantially in parallel with a bottom plate of the connection portion.

4. The female connection terminal of claim 2, wherein the slanting surface of the male connection terminal and the slanting surface of the projection are smoothly and uniformly formed.

5. The female connection terminal of claim 3, wherein the slanting surface of the male connection terminal and the slanting surface of the projection are smoothly and uniformly formed.

6. The female connection terminal of claim 1, further comprising a pair of stoppers respectively formed on opposite side edges of the resilient contact piece portion, and windows, in which stoppers are received, respectively formed through side plates of the connection portion.
